(19) United States
(12) Patent Application Publication
(10) Pub. No.: US 2007/0018348 A1
(43) Pub. Date: Jan. 25, 2007

(54) Aligned mold comprising support

(75) Inventor: Thomas R.J. Corrigan, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/185,194

(22) Filed: Jul. 20, 2005

(51) Int. Cl. B29C 33/40; B29C 59/02

(52) U.S. Cl. 264/219; 425/89; 425/403; 425/385; 977/877

(57) ABSTRACT

Molds, methods of making molds, as well as methods of making microstructured (e.g. barrier rib) articles such has display panels are described.

### BACKGROUND

Advancements in display technology, including the development of plasma display panels (PDPs) and plasma addressed liquid crystal (PALC) displays, have led to an interest in forming electrically-insulating barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

U.S. Pat. No. 6,247,986 (abstract) describes a method for molding and aligning microstructures on a patterned substrate using a microstructured mold. A slurry containing a mixture of a ceramic powder and a curable fugitive binder is placed between the microstructured surface of a stretchable mold and a patterned substrate. The mold can be stretched to align the microstructure of the mold with a predetermined portion of the patterned substrate. The slurry is hardened between the mold and the substrate. The mold is then removed to leave microstructures adhered to the substrate and aligned with the pattern of the substrate. The microstructures can be thermally heated to remove the binder and optimally fired to sinter the ceramic powder.

Although various molds and methods of aligning microstructures such as barrier ribs have been described, industry would find advantage in improvements.

### SUMMARY OF THE INVENTION

In one aspect the invention relates to a method of making a mold comprising providing an aligned mold, and providing a rigid support attached to the aligned mold.

In another aspects, the invention relates to a supported aligned mold comprising an aligned mold having a microstructured surface, and a rigid support attached to the mold.

In other aspects, the invention relates to methods of making microstructured articles with the supported aligned mold. In one embodiment, the method comprises making barrier ribs for plasma display panels by placing a curable material between the microstructured surface of the mold and a patterned substrate such as a glass panel having electrodes, curing the paste, and removing the mold. The mold is preferably transparent. The rigid support may be transparent as well. The curable material (e.g. ceramic paste) is preferably cured through the patterned substrate, through the mold, through the rigid support, or a combination thereof. The mold may be provided in a planar transfer assembly.

In each of these aspects, the rigid support preferably maintains the alignment of the mold. The aligned mold preferably has a positioning error of less than 10 ppm; whereas at least a portion of the mold prior to being aligned typically has a positioning error of 10 ppm to 100 ppm.

In one preferred embodiment, the mold is flexible. The method preferably comprises stretching the mold in order to provide the aligned mold. The mold is stretched in at least one direction and preferably in at least two different directions (e.g. wherein the second direction is substantially orthogonal to the first direction). The support is sufficiently rigid such that it limits the recovery of a stretched flexible mold to less than 5% of the total distance the mold was stretched. The elastic modulus of the support material is typically at least 5 times the elastic modulus of the mold material.

The rigid support may comprise at least one metal material, at least one polymeric material, or combination thereof. The rigid support may be attached by mechanical means, chemical means, thermal means, or a combination thereof. Alternatively, the rigid support may be provided as a molten and/or unreacted polymeric composition that is applied to the aligned mold and hardened.

The mold typically comprises a polymeric material in the form of a sheet or continuous roll. The aligned mold may correspond in size to a single plasma display panel (e.g. an areas from about 1 cm² to about 2 m²) or be a portion of a sheet or roll. The rigid support is attached to the microstructured surface of the mold, the opposing surface of the mold, or a combination thereof. The rigid support may be provided at (e.g. only) the periphery of the aligned mold. The rigid support may be a rigid film bonded to the opposing surface of the aligned mold (e.g. substantially continuous throughout the area of the aligned mold). A plurality of supported aligned molds may be provided in a (e.g. continuous) roll form.

### BRIEF DESCRIPTION OF THE DRAWINGS

FIG. 1 is a schematic representation of a plasma display panel assembly.

FIG. 2 is a schematic representation of aligning a flexible mold.

FIG. 3 is a schematic representation of an apparatus and method for aligning a mold and attaching a support.

FIG. 4 is a cross-section of a frame-shaped support being welded to an aligned mold.

FIGS. 5A-5D depict planar views of various embodied supported aligned molds.

FIG. 6 depicts another embodiment of supported aligned molds.

### DETAILED DESCRIPTION OF PREFERRED EMBODIMENTS

The present invention relates to (e.g. supported aligned) molds, methods of making molds, as well as methods of making microstructured articles (e.g. PDP back panels). In particular, the present invention is directed to molds suitable for making glass or ceramic microstructures on a substrate. While the present invention is not so limited, an appreciation of various aspects of the invention will be gained through a discussion of molds and methods suitable for the manufacture of barrier ribs for PDPs.

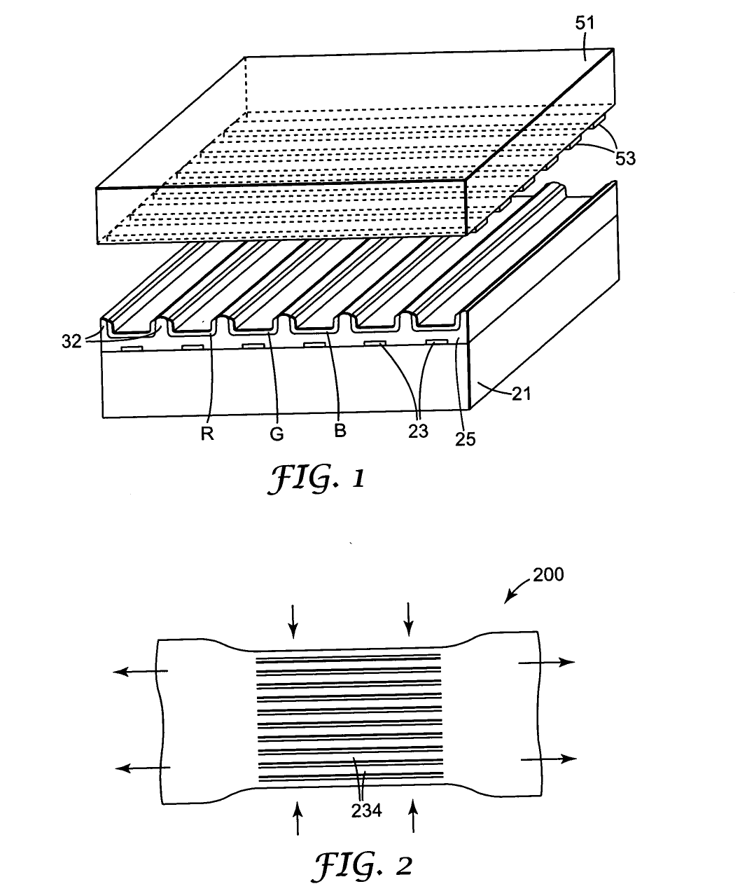

Plasma display panels (PDPs) have various components, as illustrated in FIG. 1. The back substrate, oriented away from the viewer, has independently addressable parallel electrodes 23. The back substrate 21 can be formed from a variety of compositions, for example, glass. Ceramic microstructures 25 are formed on the back substrate 21 and include barrier rib portions 32 that are positioned between electrodes 23 and separate areas in which red (R), green (G), and blue (B) phosphors are deposited. The front substrate includes a glass substrate 51 and a set of independently addressable parallel electrodes 53. These front electrodes 53, also called sustain electrodes, are oriented perpendicular to the back electrodes 23, also referred to as address electrodes. In a completed display, the area between the front and back substrate elements is filled with an inert gas. To light up a pixel, an electric field is applied between crossed sustain 53 and address electrodes 23 with enough strength to excite the inert gas atoms therebetween. The excited inert gas atoms emit ultraviolet (UV) radiation that causes the phosphor to emit red, green, or blue visible light.

Back substrate 21 is preferably a transparent glass substrate. Typically, for PDP applications back substrate 21 is made of soda lime glass. Front substrate 51 is typically a transparent glass substrate which preferably has the same or about the same coefficient of thermal expansion as that of the back substrate 21. Electrodes 23, 53 are strips of conductive material. The electrodes 23 are formed of a conductive material such as, for example, copper, aluminum, or a silver-containing conductive frit. The electrodes can also be a transparent conductive material, such as indium tin oxide, especially in cases where it is desirable to have a transparent display panel. The electrodes are patterned on back substrate 21 and front substrate 51. For example, the electrodes can be formed as parallel strips spaced about 120 μm to 360 μm apart, having widths of about 50 μm to 75 μm, thicknesses of about 2 μm to 15 μm, and lengths that span the entire active display area which can range from a few centimeters to several tens of centimeters. In some instances the widths of the electrodes 23, 53 can be narrower than 50 μm or wider than 75 μm, depending on the architecture of the microstructures 25.

The height, pitch and width of the microstructured barrier ribs portions 32 in PDPs can vary depending on the desired finished article. The height of the barrier ribs is generally at least 100 μm and typically at least 150 μm. Further, the height is typically no greater than 500 μm and typically less than 300 μm. The pitch of the barrier rib pattern may be different in the longitudinal direction in comparison to the transverse direction. The pitch is generally at least 100 μm and typically at least 200 μm. The pitch is typically no greater than 600 μm and typically less than 400 μm. The width of the barrier rib pattern may be different between the upper surface and the lower surface, particularly when the barrier ribs thus formed are tapered. The width is generally at least 10 μm, and typically at least 50 μm. Further, the width is generally no greater than 100 μm and typically less than 80 μm.

Described herein is a method of making a mold. The method comprises providing an aligned mold having a microstructured surface (e.g. suitable for making barrier ribs) and providing a rigid support attached to the mold. The rigid support improves the ability to handle the mold, particularly when the mold comprises a thin flexible material such as a polymeric film. Preferably, however, the rigid support also maintains the mold's alignment. The aligned mold, having the rigid support, (hereinafter “supported aligned mold”) is a finished mold article that can be used at a later time in the manufacture of microstructures such as barrier ribs.

The mold has two opposing major surfaces, at least one of which is a microstructured surface. The opposing surface is typically a generally planar, unstructured surface. The microstructured surface of the mold has a plurality of microstructures that represents the reverse structure of the microstructures to be formed and aligned on the patterned substrate. The mold can be made by compression molding of a thermoplastic material using a (e.g. metal) master tool that has a microstructured pattern. The mold can also be made of a curable material that is cast and cured onto a thin, flexible polymer film.

The alignment of a mold having a microstructured surface with a patterned substrate can be accomplished using various techniques that comprise positioning at least a portion of the microstructured surface. The mold prior to alignment may have a positioning error of greater than 10 parts per million (i.e. ppm, 10 microns of error over a 1 meter distance). Typically, the positioning error can range as high as 100 parts per million. After alignment, the positioning error is less than 10 parts per million.

The mold is preferably sufficiently flexible such that the aligning of the microstructured surface of the mold and the pattern of the substrate can be achieved by stretching the mold in at least one direction. For example, aligning barrier ribs with an electrode pattern of a glass panel can be accomplished by employing a flexible mold capable of being stretched, as described in U.S. Pat. No. 6,247,986. By so stretching the mold for alignment, the mold can be corrected for mold or substrate variations due to variations in processing conditions, variations in the environment (such as temperature and humidity changes), and aging which can cause slight shifting, elongation, or shrinking of the mold.

Aligning the flexible mold is preferably accomplished by stretching the flexible mold in one or more directions parallel to the plane of the substrate until the desired registry is achieved. For example, electrodes are often provided on a glass panel in a pattern of parallel lines. The microstructured surface of the mold typically comprises a plurality of depressions that create a parallel rib pattern, grid (i.e. lattice) pattern, or other pattern. With reference to a mold that creates a parallel rib, the mold may be stretched in a direction, either parallel to the substrate pattern or perpendicular to the substrate pattern, depending on whether the pitch of the mold is greater than or less than the pitch of the substrate pattern. FIG. 2 shows the case where mold 200 is stretched in a direction parallel to the parallel barrier rib pattern of the substrate 234. In this case, the pitch of the pattern of the mold is reduced during stretching to conform it to the pitch of the pattern of the substrate. To expand the pitch of the mold, the mold is stretched in the perpendicular direction.

Stretching can take place using various suitable manual and automated techniques.

For example, U.S. Pat. No. 6,247,986 describes a process particularly amenable to aligning the mold in situ during the manufacture of barrier ribs on a patterned substrate such as a glass panel having electrodes. However, this same apparatus can also be employed for stretching the (i.e. unaligned) mold to provide an aligned mold. The edges of a flexible mold (e.g. in roll form) can be attached to adjustable rollers that can increase or decrease the tension on the mold until alignment is achieved. In cases where it is desirable to stretch the mold in more than one direction simultaneously, the mold can be heated to thermally expand the mold until alignment is achieved.

As also described in U.S. Pat. No. 6,247,986 aligning of a flexible mold can be accomplished by means of static stretching method. For example, a patterned reference substrate can be provided which has protrusions or indentions located outside of the pattern of the substrate and on opposing ends of the substrate. The stretchable mold also has protrusions or indentions located outside of the microstructured pattern of the mold that align and interlock with those provided on the substrate when the mold is slightly stretched. These added interlocking features on the substrate and the mold hold the pattern of the mold in alignment with the pattern of the substrate without the use of other machinery.

In some embodiments, the flexible mold is stretched in at least two directions. For example, the mold may be stretched in a direction parallel and also in a direction perpendicular to the parallel line pattern. The stretching in a least two directions may occur either concurrently or sequentially. This may be accomplished, for example, by use of a frame apparatus attached to the periphery of a (e.g. discrete) mold as described in concurrently filed Attorney Docket No. 60232US002; incorporated herein by reference.

In yet another embodiment, a portion of the mold may be independently stretched (e.g. by different amounts) relative to a different portion of the mold. This can be accomplished by use of a segmented frame apparatus and/or a segmented mold as further described in concurrently filed Attorney Docket No. 60232US002; incorporated herein by reference.

Various stretching apparatuses suitable for alignment (e.g. stretching) of the mold can be modified to include a means for providing and attaching a rigid support. Preferably, the placement of the flexible mold in the alignment device as well as the removal of the aligned mold having the attached rigid support is accomplished by automated means.

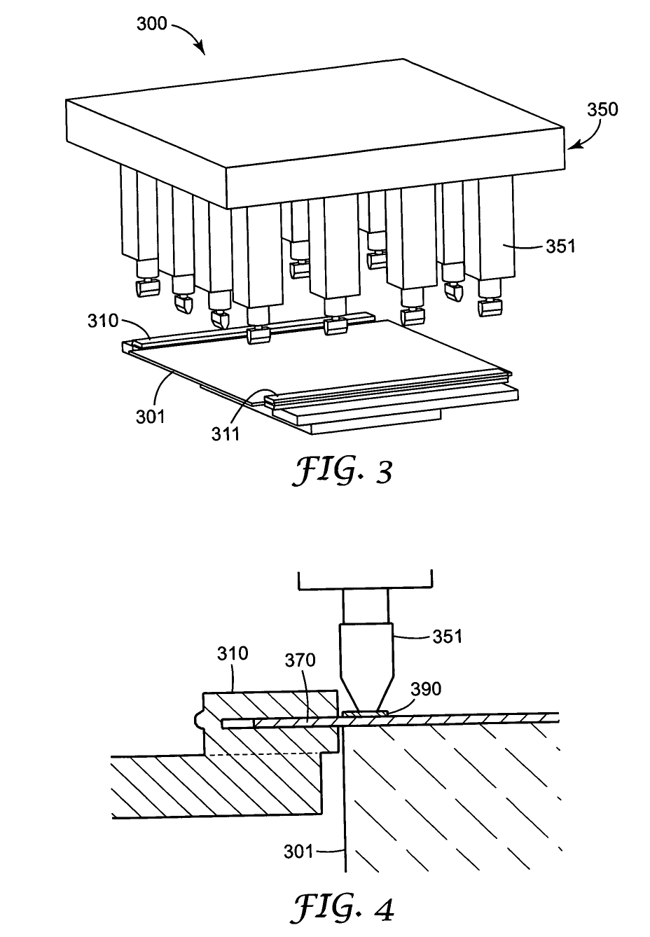

FIG. 3 depicts a perspective view and FIG. 4 depicts a cross-section view of an embodied apparatus suitable for aligning a flexible mold and attaching a rigid support to the aligned mold. The apparatus 300 includes an alignment device that includes a flat plate 301 and two continuous clamps, 310 and 311. An attachment device 350 such as a plurality of (e.g. independently actuated) ultrasonic welding devices 351 is positioned in cooperative arrangement with the alignment device. The apparatus also preferably comprises feedback devices (not shown) and a central processing system (computer, also not shown) to coordinate the movement of the various devices.

The flat plate 301 may consist of stainless steel having a thickness of about 5 mm with a 16 micro-inch surface finish. The flat plate along with the underlying support structure provides sufficient rigidity to prevent motion of the top surface of the flat plate. The flat plate may be equipped with regions to accommodate the attachment device. For example, the flat plate may be reinforced (e.g. at the periphery) to provide an anvil surface for ultrasonic welding.

The continuous clamps 310 and 311 are designed to clamp substantially the entire edge of opposing parallel edges of a flexible mold. The flexible mold may be a discrete mold, for example corresponding in dimensions to a single plasma display panel. Alternatively, the flexible mold may be a portion of a sheet or portion of a continuous roll of molds.

A patterned reference substrate (e.g. electrode patterned glass panel) may be positioned on the flat plate. Alternatively, an image of the patterned reference substrate or merely the electronic coordinates of a model reference substrate may be stored in a computer.

With reference to FIG. 4, during an embodied method, the continuous clamps are opened. A flexible mold 370 is placed on the flat plate 301, preferably unstressed (i.e. with no external forces on it). The two opposing parallel edges of the mold sheet are placed within the jaw of the open clamps 310 and 311. Both clamps are closed, gripping opposite edges of the mold sheet.

The mold sheet is stretched by means of a force applied to at least one of the continuous clamps. Although the applied force could be applied by manual means, preferably an automated system is employed that utilizes a visual feedback system to monitor the location of fiducials on the flexible mold while controlling the movement of the continuous clamps in response to the monitoring of the fiducials. The mold is then stretched such that the microstructures of the microstructured surface are aligned with a patterned reference substrate, image thereof, or model reference substrate. The rigid support may also optionally include fiducials to aid in the positioning of the mold during use in manufacturing microstructured molded articles.

After the mold has been properly aligned, a rigid support 390 is attached to the aligned mold sheet to maintain the alignment. For example, a continuous sheet of 1 m×1 m polymethyl methacrylate having a thickness of 0.125 inches, such as commercially available from Plaskolite, Inc under the trade designation “OPTIX”, can be ultrasonically bonded to an aligned mold comprised of PET such as commercially available from DuPont under the trade designation “Melinex” where the mold was aligned by being stretched by 1% in a single axis. Ultrasonic welders such as commercially available from Branson Ultrasonics under the trade designation “Branson 2000 Series 20 KHz Ultrasonic” can be employed to apply a 365 lb (803 kg) weld force, a 10 lb (22 kg) trigger force, a 0.75 second weld time, and a 50% amplitude using a 1:1.5 booster and a knurled anvil. With the area of the weld being 1.25 inches×0.5 inches (3.17 cm×1.27 cm) X, the resulting weld would have a strength of 100.1 psi (690,000 N/m²). An array of these welds, repeated every 5″ (0.13 m) at the periphery of a 1 m×1 m flexible mold sheet where each weld has an average width of 10 mm would provide 280N per 127 mm or 2,200 N/m of force, 60 times more than the calculated forced to prevent retraction of the stretched mold.

The supported aligned mold sheet may occupy a smaller area than the flexible mold from which it was formed. Varying amounts of excess flexible mold may protrude from the peripheral edges of the rigid support. The excess mold material can be trimmed off.

The rigid support typically comprises at least one plastic material, at least one metal material, as well as various combinations thereof. Although typically less preferred, the rigid support may comprise a glass or ceramic material as well. The rigid support may also be a composite such as a laminate, fiber-reinforced plastic, as well as fiber-reinforced metal. Suitable plastics include polyethylene terephthalate, polycarbonate, cellulose acetate butyrate, cellulose acetate propionate, polyether sulfone, polymethyl methacrylate, polyurethane, polyester, polyvinyl chloride, polyimide, polyolefins, polypropylene, polyethylene, and polycyclo-olefins. Suitable metals include aluminums, stainless steels, copper, brass, titanium, and alloys of the same.

The rigid support is typically premanufactured as a separate piece that is attached to the mold. Alternatively, a polymeric rigid support may be provided as a molten and/or unreacted curable composition that is applied to the aligned mold and hardened.

The design or shape of the rigid support will vary depending on the intended end us. Typically the rigid support will be largely planar, having a thin, flat cross section. Although, the thickness will vary depending on the material(s) from which it was constructed, typically the thickness of a (e.g. frame-shaped) rigid support is at least 10 mils, and no greater than about 0.5 inches (1.25 cm).

A stiffness greater than E*t=500 kN/m in the rigid support is preferable to facilitate handling. The rigid support is sufficiently stiff within the plane of the mold sheet to prevent the aligned mold sheet from deforming to its pre-aligned configuration. The rigid support may be completely inflexible. Alternatively, the rigid support may allow some degree of bending in at least one direction and thus is suitable for placement on a non-planar surface, such as a cylindrical roll as described in U.S. Provisional Patent Application Ser. No. 60/604,559, filed Aug. 26, 2004.

The dimensions of the rigid support will vary depending on the material properties of the mold sheet (e.g. modulus of Elasticity and shape), the material properties of the rigid support (e.g. modulus of Elasticity and shape) and the magnitude of stretch of the mold sheet.

By way of example, a square flexible mold sheet of 1 m×1 m in size with a thickness of 100μ may be used with a rectangular cross section frame-shaped support. The mold sheet may be stretched by a distance ΔL. If a maximum deflection in a single axis of 0.01·ΔL is chosen, a simple static analysis leads to the following equation:

$${I}_{frame support} = \frac{100}{384} \cdot \frac{{E}_{mold sheet}}{{E}_{frame support}} \cdot {thickness}_{mold sheet} \cdot {width}_{frame support}^{3} ,$$

where E represents a modulus of elasticity, and

$${I}_{frame support} = \frac{{thickness}_{frame support} \cdot {width}_{frame support edge}^{3}}{12}$$

is the moment of inertia of the edge of the frame support.

If stainless steel is used for the frame (E=190,000 Mpa) and polyethylene terephthalate for the mold sheet (E=3450 Mpa) and the modulus of elasticity values are inserted into the equation, the moment of inertia for the frame is about 4.7 E-7 m⁴. A stainless steel frame 8 mm thick and 90 mm wide would satisfy the equation. If a greater amount of relaxation would be suitable, than a smaller frame could be employed.

By way of another example a square flexible mold sheet of polyethylene terephthalate 1 m×1 m in size with a thickness of 100μ may be used with a support consisting of a second polymeric sheet of the same dimensions bonded to the perimeter of the mold sheet to maintain the alignment of the mold sheet. Assuming the two sheets are restricted in the same plane, the following equation can be derived:
F_{frame support}=F_{mold sheet}E_{frame support}·ε_{frame support}·t_{frame support}=E_{mold sheet}·ε_{mold sheet}·t_{mold sheet},
where E is the modulus of elasticity, ε=ΔL/L is the strain, and t is the thickness. Assuming the stretched sheet has a recovery of no greater than 1% of its initial stretched distance ΔL results in the following equation:
E_{frame support}·t_{frame support}=100·E_{mold sheet}·t_{mold sheet}.

For example, if polyethylene terephthalate is used for the mold sheet (E=3450 Mpa), and carbon fiber reinforced polycarbonate/acrylic (commercially available from RTP Company under the trade designation “RTP 1887A”) (E=24,100 Mpa) is used as the rigid support, then the rigid support would be 14 times thicker than the thickness of the mold sheet. At this thickness, the mold would only relax by 1% of the initial applied stretch. For a greater level of precision and to prevent excessively thick rigid supports, the relaxation of the mold sheet/rigid support combination can be predicted, or found experimentally, and compensated for. In other words, the mold can be stretched a greater distance and then relaxed to the desired alignment.

This analysis can be extended to a continuously bonded rigid support. In the limit where the length L being stretched is reduced to a differentially small portion, the same analysis holds and the same material properties are required. However, the performance required of the bond is different.

In order that the thickness of the rigid support is not magnitudes higher in thickness than the flexible mold, typically the modulus of elasticity of the rigid support material is at least 5 times that of the modulus of elasticity of the flexible. The modulus of elasticity of various materials is reported by the manufacturer. The modulus of elasticity of various conventional materials such as stainless steel is reported in various handbooks.

The rigid support may be attached to the microstructured surface of the mold, the opposing surface of the mold, or a combination thereof.

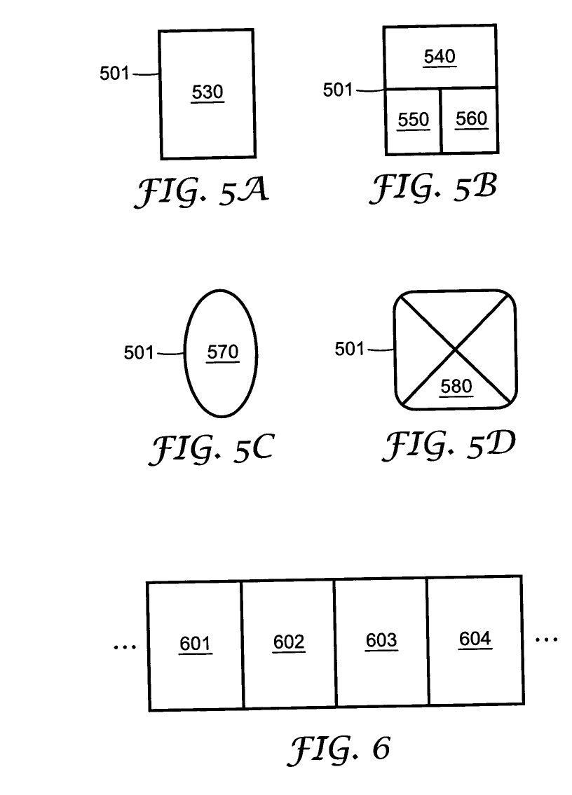

In one embodiment, the rigid support is provided as a continuous sheet (e.g. in roll form) or discrete sheet attached to the opposing surface of the mold. The rigid support is preferably frame-shaped having a single or multiple openings. The frame-shaped rigid support is attached to the outer periphery of the mold on the microstructured surface, the opposing surface, or combination thereof with the mold being provided in the opening of the frame. In one embodiment, the mold may comprise an unstructured (i.e. non-rib) region that occupies a periphery region of the mold as described in WO 2004/064104. The frame-shaped rigid support is attached to this unstructured region. Providing a frame-shaped support attached to the microstructured surface in this manner advantageously can also function as a template as described U.S. patent application Ser. No. 60/604,557, filed Aug. 26, 2004. In other embodiments, depicted in FIGS. 5A-5C and in FIG. 6, frame-shaped rigid supports 501 are provided on the opposing surface of the mold(s) 530, 540, 560, 570 and 580.

The rigid support (e.g. frame-shaped, continuous sheet) may have various shapes such as rectangular, as depicted in FIG. 5A, and circular, as depicted in FIG. 5C. Two or more supported aligned molds may be attached to other supported aligned molds to create various arrangements. For example, FIG. 5B depicts a frame-shaped support having multiple openings wherein discreet aligned molds, 540, 550, and 560 are each bound by a frame. The rigid support may be an assembly of two or more individual parts optionally bonded to each other. For example, the rigid support may comprise two rigid support members positioned diagonally as depicted in FIG. 5D. In another embodiment, a plurality of supported aligned molds 601, 602, 603, and 604 are provided in a continuous roll of aligned mold sheets as depicted in FIG. 6. Such a continuous arrangement can be advantageous for handling, storage, and automation of the manufacture of barrier ribs from the supported aligned mold sheets.

For embodiments wherein the aligned supported mold will subsequently be used for molding a composition curable by exposure to radiation, it is preferred that the mold is sufficiently transparent such that the curable composition can be cured through the mold. For this embodiment, it is also preferred that the rigid support is provided in a manner such that it does not detract from this use. In one embodiment, this can be accomplished by providing the rigid support outside of the moldable region of the mold by use of a frame-shaped rigid support attached to the outer periphery of the mold. In another embodiment, this can be accomplished by employing a rigid support that is sufficiently transparent such that the curable composition can be cured through the rigid support.

Although, the rigid support may be temporarily attached to the aligned mold, it is preferred that the rigid support is permanently attached. Permanently attached means that the rigid support cannot be removed from the mold without appreciably damaging the mold. The rigid support may be attached to the mold by various known means including mechanical means, chemical means, thermal means, as well as various combinations thereof. Chemical means include includes the use of various one and two-part curable adhesive compositions that crosslink upon exposure the heat, moisture, or radiation. For example a 10 mm wide bead of an epoxy adhesive, such as commercially available from 3M Company, St. Paul, Minn. under the trade designation “Scotch-Weld DP-100 Clear” can be used to bond a PET aligned mold (e.g. stretched by 100 microns) to a PMMA support.

Mechanical means include as examples clamps, stitching, staples, rivets, brackets, hooks, and hook and loop fasteners. In yet another embodiment, a two-part frame-shaped rigid support is employed wherein each frame-shaped rigid support has protrusions or indentions that interlock with each other such that the aligned mold is provided in the opening of the interlocked frames.

Other attachment means include various thermal means including for example a heated embossed roller, radio frequency (RF) welding, and ultrasonic welding. Radio frequency (RF) welding is a preferred attachment technique for the bonding of polymeric molds to polymeric rigid supports. The frequency of the radio frequency energy and the field strength are variable by an operator and chosen for suitability dependent upon the polymeric components of the mold and the rigid support. The choice depends on such factors as the individual polymeric dielectric loss factors, dielectric constants, melting temperatures, and layer thickness. The radio frequency energy is delivered through antennas mounted within appropriate platens that are pressed onto the appropriate surfaces applying an appropriate amount of pressure and an appropriate duration of radio frequency energy. Reference is made to the article “RF Welding of PVC and Other Thermoplastic Compounds” by J. Leighton, T. Brantley, and E. Szabo in ANTEC 1992, pps. 724-728 as well as to U.S. Pat. No. 5,962,108, incorporated herein by reference.

When the support is bonded only at the edges of the aligned flexible mold sheet, then the total force from that sheet's strain (due to stretching) is passed to the rigid support along the edge of the sheet. For a single axis of stretching in a mold sheet, the required force per unit length can be calculated as according to the following equation:

$$\begin{matrix}{F}_{per unit length} = \frac{{E}_{mold sheet} \cdot {ɛ}_{mold sheet} \cdot {w}_{mold sheet} \cdot {t}_{mold sheet}}{{w}_{mold sheet}} \\ = \frac{{E}_{mold sheet} \cdot Δ {L}_{mold sheet} \cdot {t}_{mold sheet}}{{L}_{mold sheet}} ,\end{matrix}$$

By way of example, for a strain of 0.0001 (stretched 100μ over 1 m) the force would be F=34.5 N/m (t=100μ, E=3450 Mpa). Note that the force is directly related to the strain, so if a stretch of 1 mm (i.e. 1%) was applied to align the mold, then the force would be 10 times greater, around 345 N/m.

A typical coefficient of friction between steel and polyethylene is 0.2 (Machinery's Handbook). A clamping mechanism holding the edge of a 1 m×1 m mold sheet, stretched by 100 microns, would provide 35N/0.2=175N [39 lb] of clamping force. Accordingly, a simple mechanical clamping mechanism such as a scissors style clamp loaded with one or more compression springs could easily deliver more than the 40 lb of clamping force necessary to keep the mold sheet bound to the rigid support. The clamping force is preferably distributed across all the edges of the two clamps and primarily in the corners to prevent the deformation of the stretched mold sheet in regions where it is not clamped.

The microstructured flexible (e.g. unaligned) mold is preferably formed according to a process similar to the processes disclosed in U.S. Pat. No. 5,175,030 (Lu et al.) and U.S. Pat. No. 5,183,597 (Lu). The formation process preferably includes the following steps: (a) preparing an oligomeric resin composition; (b) depositing the oligomeric resin composition onto a master negative microstructured tooling surface in an amount barely sufficient to fill the cavities of the master; (c) filling the cavities by moving a bead of the composition between a preformed substrate and the master, at least one of which is flexible; and (d) curing the oligomeric composition. A preferred master is a metallic tool. If the temperature of the curing and optional simultaneous heat treating step is not too great, the master can also be constructed from a thermoplastic material, such as a laminate of polyethylene and polypropylene.

The oligomeric resin composition of step (a) preferably is a one-part, solvent-free, (e.g. radiation polymerizable) crosslinkable, organic oligomeric composition. The oligomeric composition is preferably curable to form a flexible and dimensionally-stable cured polymer. The curing of the oligomeric resin preferably occurs with low shrinkage. The Brookfield viscosity of the oligomeric resin is typically at least 10 cps and typically no greater than 35,000 cps and more preferably has a viscosity in the range of 50 cps to 10,000 cps.

Preferred oligomeric compositions comprise at least one acryl oligomer and at least one acryl monomer such as described in oligomeric resin compositions are described in PCT application no. US04/26845 filed Aug. 18, 2004; PCT Publication No. WO2005/021260 and U.S. patent application Ser. No. 11/107,554, filed Apr. 15, 2005.

Polymerization can be accomplished by typical means, such as heating in the presence of free radical initiators, irradiation with ultraviolet or visible light in the presence of suitable photoinitiators, and by irradiation with electron beam. For reasons of convenience, low capital investment, and production speed, the preferred method of polymerization is by irradiation with ultraviolet or visible light in the presence of photoinitiator at a concentration of about 0.1 percent to about 1.0 percent by weight of the oligomeric resin composition.

Various materials can be used for the base (substrate) of the flexible mold. Typically the material is substantially optically clear to the curing radiation and has enough strength to allow handling during casting of the microstructure. In addition, the material used for the base can be chosen so that it has sufficient thermal stability during processing and use of the mold. Polyethylene terephthalate or polycarbonate films are preferable for use as a substrate in step (c) because the materials are economical, optically transparent to curing radiation, and have good tensile strength. Substrate thicknesses of 0.025 millimeters to 0.5 millimeters are preferred and thicknesses of 0.075 millimeters to 0.175 millimeters are especially preferred. Other useful substrates for the microstructured mold include cellulose acetate butyrate, cellulose acetate propionate, polyether sulfone, polymethyl methacrylate, polyurethane, polyester, and polyvinyl chloride. The surface of the substrate may also be treated to promote adhesion to the oligomeric composition.

Examples of suitable polyethylene terephthalate based materials include: photograde polyethylene terephthalate; and polyethylene terephthalate (PET) having a surface that is formed according to the method described in U.S. Pat. No. 4,340,276, incorporated herein by reference.

The hardness of the base mold substrate (e.g. plastic film) can be expressed by rigidity against tension, for example, or by tensile strength. The tensile strength of the base mold substrate is generally at least about 5 kg/mm² and preferably at least about 10 kg/mm². When the tensile strength of the base mold substrate is lower than 5 kg/mm², handling property drops when the resulting mold is released from the mold or when the PDP ribs are released from the mold, so that breakage and tear are likely to occur. However, lower strength mold base substrate may be utilized in view of the strength provided by the rigid support.

The supported aligned mold described herein can be used in various known methods as described in the art. The method generally comprises providing a curable material between the microstructured surface of the mold and an electrode patterned glass panel, curing the paste; and removing the mold. The mold is typically transparent. The paste may be cured through the glass panel, though the mold, through the support, or a combination thereof.

A suitable curable material for forming the microstructures can be provided between the mold and the patterned substrate (e.g. glass panel) in a variety of ways. The material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. Regardless of the manner employed, care should be taken minimize entrapment of air.

The molding material is preferably a slurry or paste containing a mixture of at least three components. The first component is a ceramic powder. The ceramic material of the slurry will ultimately be fused or sintered by firing to form microstructures having desired physical properties adhered to the patterned substrate. The second component is a fugitive binder that is capable of being shaped and subsequently hardened by curing or cooling. The binder allows the slurry to be shaped into semi-rigid green state microstructures that are adhered to the substrate so that the stretchable mold used to form and align the microstructures can be removed in preparation for debinding and firing. The third component is a diluent that can promote release from the mold after alignment and hardening of the binder material, and can promote fast and complete burn out of the binder during debinding before firing the ceramic material of the microstructures. The diluent preferably remains a liquid after the binder is hardened so that the diluent phase-separates from the binder material during binder hardening. Various paste compositions are known and described for example in U.S. patent application Ser. No. 11/107,608, filed Apr. 15, 2005 and PCT Publication WO2005/019934.

The patterned substrate is able to withstand the temperatures necessary to process the ceramic material of the slurry. Glass or ceramic materials suitable for use in the slurry preferably have softening temperatures below about 600° C., and usually between about 400° C. and 600° C. Thus, a preferred choice for the substrate is a glass, ceramic, metal, or other rigid material that has a softening temperature higher than that of the ceramic material of the slurry. Preferably, the substrate has a softening temperature that is higher than the temperature at which the microstructures are to be fired. In addition, glass or ceramic materials suitable for use in the slurry of the present invention preferably have coefficients of thermal expansion of about 5×10⁻⁶/° C. to about 13×10⁻⁶/° C. Thus, the substrate preferably has a CTE approximately in this range as well.

Various other aspects that may be utilized in the invention described herein are known in the art including, but not limited to each of the following patents that are incorporated herein by reference: U.S. Pat. No. 6,247,986; U.S. Pat. No. 6,537,645; U.S. Pat. No. 6,713,526; WO 00/58990, U.S. Pat. No. 6,306,948; WO 99/60446; WO 2004/062870; WO 2004/007166; WO 03/032354; WO 03/032353; WO 2004/010452; WO 2004/064104; U.S. Pat. No. 6,761,607; U.S. Pat. No. 6,821,178; WO 2004/043664; WO 2004/062870; PCT Application No. US04/33170, filed Oct. 8, 2004; PCT Application No. US04/26701, filed Aug. 17, 2004; PCT Application No. US04/26845, filed Aug. 18, 2004; PCT Application No. US04/23472 filed Jul. 21, 2004; PCT Application No. US04/32801 filed Oct. 6, 2004; PCT Application No. US04/43471 filed Dec. 22, 2004; U.S. Patent Application Ser. Nos. 60/604,556, 60/604,557, 60/604,558 and 60/604,559, each filed Aug. 26, 2004.

What is claimed is:

1. A method of making an aligned supported mold comprising:
providing an aligned mold having a microstructured surface suitable for making barrier ribs; and
providing a rigid support attached to the aligned mold.

2. The method of claim 1 wherein the rigid support maintains the alignment of the mold.

3. The method of claim 1 wherein the aligned mold has a positioning error of less than 10 ppm.

4. The method of claim 1 wherein the mold prior to being aligned has a positioning error ranging from 10 ppm to 100 ppm.

5. The method of claim 1 wherein the mold is flexible.

6. The method of claim 5 wherein the method comprises stretching the mold in order to provide the aligned mold.

7. The method of claim 6 wherein the mold is stretched in a first direction and a second direction, substantially orthogonal to the first direction.

8. The method of claim 5 wherein the mold is stretched a distance and the aligned mold recovers less than 5% of the distance.

9. The method of claim 1 wherein the mold and rigid support are each comprised of a material having an elastic modulus and the elastic modulus of the support material is at least 5 times the elastic modulus of the mold material.

10. The method of claim 1 wherein the rigid support is attached by mechanical means, chemical means, thermal means, or a combination thereof.

11. The method of claim 1 wherein the mold corresponds in size to a single plasma display panel.

12. The method of claim 11 wherein the mold has an areas ranging from about 1 cm² to about 2 m².

13. The method of claim 1 wherein the mold is a portion of a sheet or roll.

14. A supported aligned mold comprising:
an aligned mold having a microstructured surface; and
a rigid support attached to the mold.

15. The supported aligned mold of claim 14 wherein the mold comprises a polymeric sheet.

16. The supported aligned mold claim 14 wherein the rigid support comprises at least one metal material, at least one polymeric material, or combination thereof

17. The supported aligned mold of claim 14 wherein the rigid support is attached to the microstructured surface of the mold, the opposing surface of the mold, or a combination thereof.

18. The supported aligned mold of claim 14 wherein the rigid support is provided at the periphery of the aligned mold.

19. The supported aligned mold of claim 16 wherein the rigid support is a transparent film that is substantially continuous throughout the area of the aligned mold.

20. A plurality of supported aligned molds of claim 16 provided in a roll form.

21. A method of making barrier ribs for plasma display panels comprising:
providing the support aligned mold of claim 16 wherein the microstructured surface is suitable for making barrier ribs;
providing a curable material between the microstructured surface of the mold and an electrode patterned glass panel;
curing the paste; and
removing the mold.

22. A method of making a mold comprising:
providing an aligned mold having a microstructured surface; and
attaching a rigid support to the aligned mold.
